(19) United States
(12) Patent Application Publication
(10) Pub. No.: US 2015/0336248 A1
(43) Pub. Date: Nov. 26, 2015

(54) Power Drill Having Torque Setting Mechanism

(71) Applicant: Kevin Goe, Angleton, TX (US)

(72) Inventor: Kevin Goe, Angleton, TX (US)

(21) Appl. No.: 14/613,230

(22) Filed: Feb. 3, 2015

Related U.S. Application Data
(60) Provisional application No. 62/000,776, filed on May 20, 2014.

(51) Int. Cl. B25B 23/147; B25F 5/00; B25B 21/00

(52) U.S. Cl. CPC B25B 23/147; B25B 21/00; B25F 5/001

(57) ABSTRACT

A hand-held power drill having a torque setting mechanism. The power drill includes a drill housing that encloses a motor that rotatably drives a drill chuck in which a drill bit can be positioned. The housing further includes a control circuit having a microprocessor, a torque sensor, a motor speed control, and a torque setting mechanism. The torque setting mechanism allows the user to enter the desired amount of torque to be applied by the drill and includes a display indicating the current torque setting. The torque sensor measures the amount of torque currently applied, and if the torque output differs from the torque setting, then the motor speed control adjusts the speed of the motor in order to achieve the desired torque setting. In this way, the speed of the motor automatically changes to adjust the torque when a user inputs the desired amount of torque.

### CROSS REFERENCE TO RELATED APPLICATION

This application claims the benefit of U.S. Provisional Application No. 62/000,776 filed on May 20, 2014. The above identified patent application is herein incorporated by reference in its entirety to provide continuity of disclosure.

### BACKGROUND OF THE INVENTION

1. Field of the Invention

The present invention relates to hand-held power drills. More specifically, the present invention relates to a hand-held power drill having an electronic torque setting mechanism. The torque setting mechanism can be used to set the amount of torque applied by the drill's motor, and the device further includes a display that shows the amount of torque being applied by the drill while the drill is in use.

Fasteners such as screws and bolts are often over-tightened, causing the fasteners to break or crack. A damaged fastener may compromise the integrity of the connection that it is used to support. Thus, many fasteners have precise specifications as to the amount of torque that can be applied to the fastener without breaking or otherwise damaging the fastener. Further, if a fastener is over-tightened, the fastener may stress the material in which it is inserted, reducing stability.

While it is important to install fasteners using a proper amount of torque in order to avoid breaking the fastener, many power drills do not include means for monitoring the torque provided thereby while the drill is in use. Thus, when a user is installing a fastener, the user has no way of knowing the amount of torque being applied, and must apply the correct amount of torque based on experience. However, even an experienced worker cannot always accurately install fasteners with the appropriate amount of torque, and may desire a way to more easily determine the amount of torque being applied.

Thus, the present invention provides a hand-held power drill having a torque setting mechanism. The power drill may include any type of drill or similar power tool having a motor that rotatably drives an output shaft or drill bit. The power drill includes a control circuit having a microprocessor, a torque sensor, a torque setting mechanism, and a motor speed control. The torque setting mechanism allows a user to select the amount of torque desired to be applied by the drill bit using one or more control switches, and further includes a digital display for showing the current torque setting. Once the user sets the desired amount of torque, the torque sensor determines the current torque output, and alters the motor speed via the motor speed control in order to achieve the desired amount of torque. In this way, a user can easily determine the amount of torque being applied, and can monitor the torque being applied while the drill is in use. This helps the user to avoid problems related to over-tightening fasteners, and helps to ensure that the fastener is securely installed.

2. Description of the Prior Art

Devices have been disclosed in the prior art that relate to tools with torque controlling mechanisms. These include devices that have been patented and published in patent application publications. These devices generally relate to wrenches or power drills having torque controlling or limiting mechanisms. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 8,485,075 to Gauthier et al. discloses an electronic torque wrench. The wrench includes electronics adapted to sense and measure the torque applied to a fastener by the wrench. The wrench further outputs the level of torque to the user. The wrench can provide the user with visual, audible, and tactile feedback regarding the operation thereof relative to maximum torque values. Thus, Gauthier discloses a wrench that determines the torque applied thereby, and fails to disclose a hand-held power drill having a torque setting mechanism and a display for indicating the torque setting.

U.S. Pat. No. 8,316,959 to Roehm discloses a hand-held power tool having a torque limiting device for setting a maximum torque. The device includes a spring mechanism having at least one disk spring. The disk spring acts on two or more detent mechanisms arranged circumferentially. Thus, Roehm fails to disclose a power tool having a torque sensor and a motor speed control that automatically adjusts the speed of the motor to provide the desired torque output as set by a user.

U.S. Pat. No. 7,487,844 to DeCicco et al. discloses a drill having a speed control. The device includes a solid-state motor control. A solid state variable speed control signal generator produces a variable speed control signal, and a microcontroller generates a pulse width modulated signal that corresponds to the variable speed control signal. A driver circuit is used to generate H-bridge driving signals corresponding to the pulse width modulated signal. An H-bridge circuit couples to a motor and power source based upon the H-bridge driving signals. Thus, DeCicco et al. discloses a drill having a speed control, and does not provide a drill having a torque limiting or torque setting mechanism.

U.S. Pat. No. 7,107,884 to Cutler et al. discloses an electronic torque wrench. The device includes a tubular core having elongated apertures that removably receive a user interface assembly and power assembly. A workpiece-engaging head is coupled to a beam member. A sensor on the beam member is connected to the user interface assembly, which includes a display producing a graph that indicates the proximity of a measured torque value to a preset torque value. Thus, Cutler et al. provides a wrench having torque indicating ability, and does not include a power drill having a means for setting and monitoring the torque produced thereby.

Finally, U.S. Published Patent Application Number 2009/0249924 to Lin discloses a torque-indicating apparatus. The apparatus includes a handle, bits, and a torque indicating apparatus provided between the handle and a bit. The torque indicating apparatus includes an extensive rod, at least one sensor, and a display unit. The sensor is attached to the extensive rod and is used to sense the torque in the extensive rod. The sensor sends a signal to the display unit that shows a reading of the torque based upon the signal. Thus, Lin discloses an apparatus to be used with a wrench for determining torque, and does not disclose a power drill having a torque setting mechanism.

These prior art devices have several known drawbacks. Several devices in the prior art relate to tools having torque-limiting mechanisms. Many of these devices relate to wrenches that indicate the torque applied thereby. Thus, these devices do not provide torque limiting mechanisms on hand-held power drills or other similar devices having an output shaft or bit rotatably driven by a motor. Further, devices in the prior art relating to drills do not provide a motor speed control and a torque sensor for automatically adjusting the torque output by the drill to the torque set by the user.

In light of the devices disclosed in the prior art, it is submitted that the present invention substantially diverges in design elements from the prior art and consequently it is clear that there is a need in the art for an improvement to existing power drills having torque limiting mechanisms. In this regard the instant invention substantially fulfills these needs.

### SUMMARY OF THE INVENTION

In view of the foregoing disadvantages inherent in the known types of hand-held power drills now present in the prior art, the present invention provides a new hand-held power drill device wherein the same can be utilized for providing convenience for the user when installing fasteners with a desired amount of torque.

It is therefore an object of the present invention to provide a new and improved hand-held power drill device that has all of the advantages of the prior art and none of the disadvantages.

It is another object of the present invention to provide a hand-held power drill device comprising a digital display that indicates the amount of torque being applied by the drill.

Another object of the present invention is to provide a hand-held power drill device having a torque setting mechanism comprising control switches for setting the amount of torque applied by the drill and for setting the units of measurement in which the torque is displayed.

Yet another object of the present invention is to provide a hand-held power drill device that automatically adjusts the drill's motor speed and thus the torque output to the torque setting as input by the user.

A further object of the present invention is to provide a hand-held power drill device comprising a torque setting mechanism having a control circuit that includes a microprocessor, a torque sensor, a motor speed control, and a power source.

Another object of the present invention is to provide a drill device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the drill device of the present invention.

FIG. 2 shows a close-up view of the digital display of the drill device of the present invention.

FIG. 3 shows a schematic view of the control circuit of the present invention.

FIG. 4 shows a flow chart of the operation of the drill device of the present invention.

### DETAILED DESCRIPTION OF THE INVENTION

Reference is made herein to the attached drawings. Like reference numerals are used throughout the drawings to depict like or similar elements of the hand-held power drill of the present invention. For the purposes of presenting a brief and clear description of the present invention, the preferred embodiment will be discussed as used for installing fasteners using a desired amount of torque. The figures are intended for representative purposes only and should not be considered to be limiting in any respect.

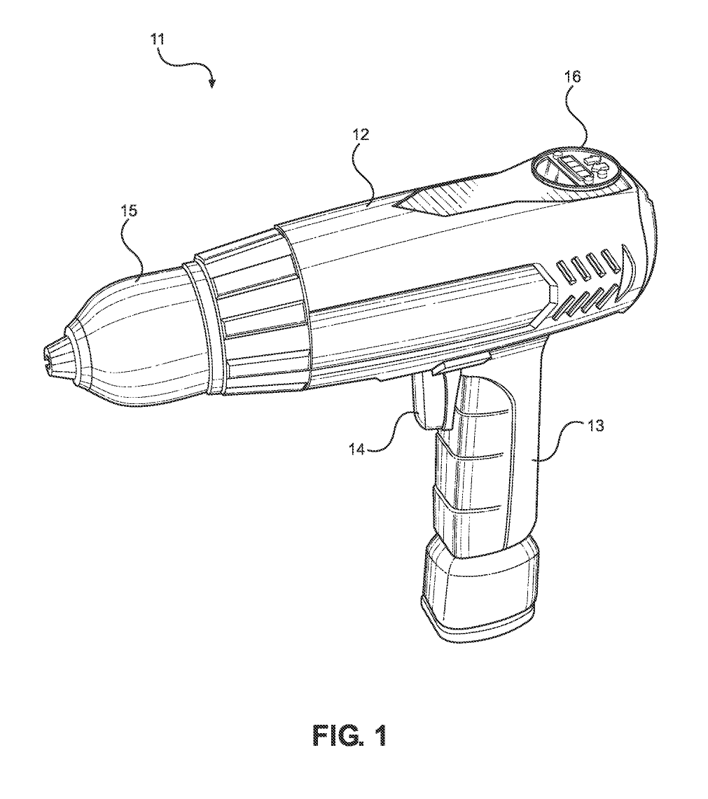

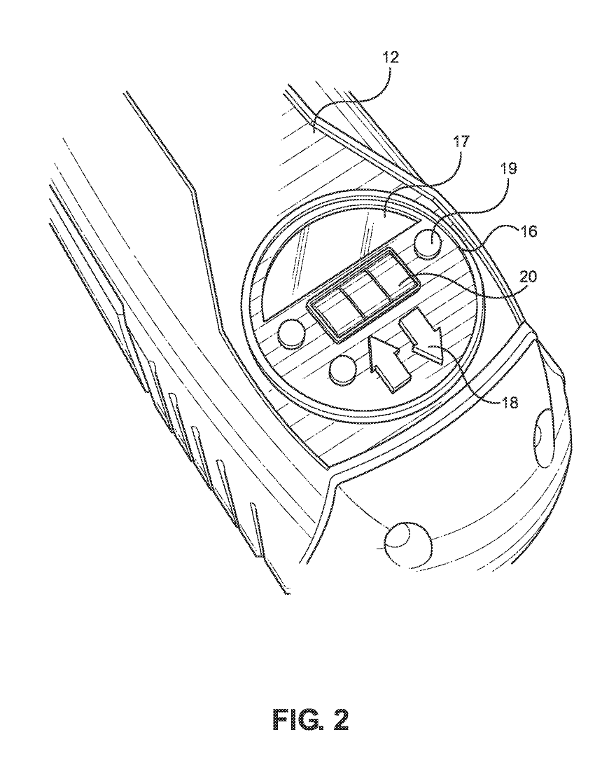

Referring now to FIGS. 1 and 2, there is shown a perspective view of an embodiment of the drill device of the present invention and a close-up view of the digital display thereon. The present invention provides a hand-held power drill 11 having an electronic torque setting mechanism 16. The power drill 11 may include a traditional power drill or other similar power tool having a motor that rotatably drives an output shaft, drill bit, or the like. In a preferred embodiment, the drill 11 includes a housing 12 that encloses a motor. The housing 12 further encloses a gear set connected to the motor for adjusting the rotational output thereof. A spindle or shaft having a drill chuck thereon is driven by the motor and gear set. Any of a variety of drill bits can be positioned and held within the drill chuck so that the drill bit can be rotationally driven by the motor. The motor is powered by a rechargeable battery that can be removably positioned on the drill 11. The housing further includes a handle 13 thereon that is roughly perpendicular to the spindle or shaft of the drill 11. The handle 13 includes a trigger 14 for selectively powering the motor.

The torque setting mechanism 16 of the drill 11 includes a digital display 20 and one or more control switches 18, 19 for adjusting the torque setting. Preferably, the torque setting mechanism 16 is located on an upper portion of the housing 12. The control switches 18 may include push-button switches for increasing or decreasing the amount of torque indicated on the display 20. The digital display 20 is adapted to display the amount of torque currently applied by the drill 11 as set by the user. The display 20 can be set to indicate torque in a particular unit of measurement, and includes a control switch 19 for changing the units in which torque is measured. Accordingly, the torque setting mechanism 16 may include a second display 17 on which the units of measurement are indicated. Thus, the torque setting mechanism 16 allows a user to easily adjust the torque output by the drill 11, and allows the user to easily monitor or determine the torque output of the drill 11.

In an alternative embodiment of the present invention, the display 20 may show both the torque set by the user and also the current torque output by the drill. In this way, the user can determine if the torque output is at or near the desired amount of torque, and the display 20 will show slight deviations in the amount of torque applied by the drill during use. In some embodiments of the present invention, the display 20 may indicate the maximum amount of torque desired to be applied by the drill.

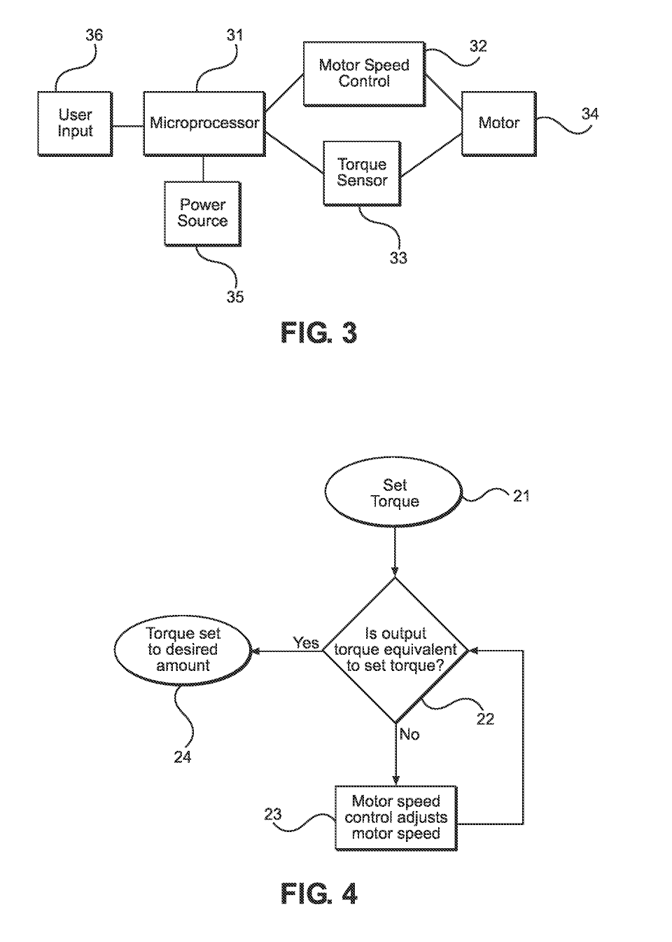

Referring now to FIG. 3, there is shown a diagram of the control circuit of the present invention. The drill of the present invention includes a control circuit having a microprocessor 31 adapted to electronically control the torque output so that it corresponds to the torque input by the user. The microprocessor 31 is in electrical connection with a user input means 36 so as to receive input regarding the desired torque setting. The user input means 36 corresponds to the torque setting mechanism having one or more control switches that allow the user to input the desired torque setting. Further, the microprocessor 31 is powered by a power source 35, such as one or more batteries. The power source 35 may be the same power source as used to power the drill's motor, or may be a separate power source.

The microprocessor 31 communicates with a motor speed control 32 and a torque sensor 33. The motor speed control 32 is adapted to increase or reduce the rotational speed of the motor 34. The torque sensor 33 measures the torque output by the motor 34, and the microprocessor 31 determines whether the torque output by the motor 34 is equal to the torque set by the user. If the torque output is less than the torque set by the user, the motor speed control 32 increases the rotational speed of the motor 34. Conversely, if the torque output is greater than the torque set by the user, the motor speed control 32 decreases the rotational speed of the motor 34. Thus, the motor speed is adjusted by means of the motor speed control 32 until the torque output matches the torque set by the user.

Referring now to FIG. 4, there is shown a flow chart of the operation of the drill device of the present invention. In operation, the user sets the torque 21 as indicated on the digital display by operating the control switches on the torque setting mechanism of the drill. The user can increase or decrease the torque to the desired amount by operating the controls switches. The drill then determines whether the torque output 22 is equal to the torque set by the user. The motor includes a torque sensor thereon for measuring the torque output of the drill. If the torque output is not equal to the torque set by the user, the motor speed control adjusts the speed of the motor 23 in order to alter the amount of torque produced thereby. The drill then rechecks whether the torque output is equal to the torque set 22. The motor speed control adjusts the speed of the motor in this fashion until the output torque is equal to the torque setting. Thus, the drill automatically adjusts the motor speed and the torque of the drill to match the desired amount of torque 24 as input by the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A power drill having a torque setting mechanism, comprising:
a motor enclosed within a drill housing, wherein said motor is adapted to rotatably drive a drill bit;
a control circuit comprising a torque sensor, a motor speed control, a torque setting mechanism, and a microprocessor;
said torque setting mechanism adapted for accepting user input of a set torque amount to be provided by said motor;
said torque sensor operably connected to said motor and adapted to measure a torque output of said motor;
said motor speed control operably connected to said motor and adapted to adjust the speed of said motor such that said torque output matches said set torque amount.

2. The power drill of claim 1, wherein said torque setting mechanism comprises a digital display adapted to display said set torque amount, and one or more control switches for adjusting said set torque amount.

3. The power drill of claim 2, wherein said digital display is further adapted to show the units in which torque is measured.

4. The power drill of claim 2, wherein one of said one or more control switches changes the unit of measurement in which torque is displayed.

5. The power drill of claim 1, wherein said motor is powered by a rechargeable battery removably secured to said drill housing.

6. The power drill of claim 1, wherein said microprocessor is in electrical communication with said torque sensor, said motor speed control, and torque setting mechanism.

7. A power drill having a torque setting mechanism, comprising:
a motor enclosed within a drill housing, wherein said motor is adapted to rotatably drive a drill chuck adapted to hold a drill bit therein;
a control circuit comprising a microprocessor in electrical communication with a torque sensor, a motor speed control, and an electronic torque setting mechanism;
said electronic torque setting mechanism adapted to input a set torque amount to be provided by said motor;
said torque sensor operably connected to said motor for measuring a torque output;
said motor speed control operably connected to said motor for adjusting the speed of said motor such that said torque output matches said set torque amount.

8. The power drill of claim 7, wherein said electronic torque setting mechanism comprises a display and one or more control switches for adjusting said set torque amount.

9. The power drill of claim 8, wherein said electronic torque setting mechanism further comprises a second display on which the units of measurement are indicated.
